(19) United States
(12) Patent Application Publication
(10) Pub. No.: US 2010/0166025 A1
(43) Pub. Date: Jul. 1, 2010

(54) High-power short-wavelength fiber laser device

(75) Inventors: Yuri Grapov, Sutton, MA (US); William D. Jones, Wrentham, MA (US)

Correspondence Address: IPG PHOTONICS CORPORATION, 50 OLD WEBSTER ROAD, OXFORD, MA, 01540, US

(73) Assignee: IPG Photonics Corporation

(21) Appl. No.: 12/319,069

(22) Filed: Dec. 31, 2008

(51) Int. Cl. H01S 3/30

(52) U.S. Cl. 372/5; 372/6

(57) ABSTRACT

A high-power, short-wavelength fiber laser device combines the known advantages and well-developed technology of long-wavelength fiber lasers with the concepts of both non-linear frequency doubling and non-linear sum frequency mixing to generate visible blue laser light at a wavelength of about 427 nm. The device includes a thulium fiber laser emitting light at a wavelength of 1900 nm, and an erbium fiber laser emitting light at a wavelength of 1550 nm. The light from each of the fiber lasers is frequency doubled in respective non-linear converters, resulting in respective light sources at 950 nm and 775 nm. The resulting 950 nm and 775 nm light is combined and mixed in a non-linear sum frequency mixer to produce a single short-wavelength beam of light having a wavelength of about 427 nm.

### BACKGROUND OF THE INVENTION

The instant invention relates to fiber laser devices, and more particularly to a high-power fiber laser device operating in the short wavelength (visible light) spectrum. Even more specifically, the invention relates to a high-power fiber laser device operating in the blue wavelength spectrum.

Rare-earth doped fiber lasers are well established in the art and have achieved significant commercial success in many different areas, including telecommunications, industrial cutting and marking, and also in the field of medicine. The majority of the rare-earth gain materials that are used in fiber lasers have their most efficient spectral emissions in the near infrared and infrared spectrums above 900 nm. Accordingly, high-power fiber lasers in the orders of tens to hundreds of multi-watts are typically associated with longer wavelengths. However, there is a defined need for high-power fiber lasers in the short wavelength spectrum for a variety of applications.

One particular need in the medical area is a fiber laser in the blue light spectrum between 400 nm to 500 nm. Hemoglobin, a key constituent of blood and tissue, is highly absorptive of light between 400 nm and 600 nm, which includes both blue light (at the lower end) and green light (at the higher end). A laser operating in this range is highly effective for cutting tissue, but is also known to explode hemoglobin, which coagulates blood and limits bleeding. Accordingly, lasers in this wavelength range are ideal for surgical procedures because of their accuracy and ability to limit bleeding. Green lasers are available for this application. However, the longer green wavelengths have higher energy, and tend to cut too deeply or too quickly, and thus are not as desirable as the shorter wavelength blue light. Blue light having a wavelength between 400 nm and 500 nm seems to be the perfect combination of power and wavelength for surgical applications.

Another need is in the area of photodynamic therapy (PDT), which is a technique for location-specific treatment of cancerous tumors and lesions. Its advantages are that the process is localized to the tumor tissue so that relatively little damage occurs to the surrounding healthy tissue, and the procedure can be done without surgery. The PDT technique usually begins with the administration of a photosensitizer drug, topically, locally or systematically, to the patient followed by irradiation of the tumor or lesion by light, which causes selective damage to the tumor tissue. Many of the known photosensitizer drugs are activated with light in the visible light spectrums, far below the long wavelength spectrums of traditional fiber lasers. Blue lasers would be highly useful in surgical procedures for prostate cancer where the ability to limit bleeding in the urinary tract would be highly desirably.

Blue lasers could also be highly useful in the dental field for curing resins and other adhesives that are activated by light in the blue wavelength spectrum. Currently, the dental field uses lamps, which have a broad spectrum that includes blue light but also includes more harmful UV light. A focused source of light in the blue wavelength spectrum would thus be useful in this area as well.

While short wavelength, and more specifically blue, lasers are known in the art, each existing type of blue laser has shortcomings. Short-wavelength semiconductor diode lasers in the blue light spectrum are known to be low power and are not viable for cutting tissue. Short wavelength chemical lasers are often too powerful for these types of focused energy applications. Finally, short-wavelength fiber lasers are known to be difficult to manufacture because of the requirements of specific wavelengths and the lack of doping materials that have emissions at the desired wavelengths.

Although fiber lasers having short wavelength beams are difficult to manufacture, one known technique for achieving short-wavelength emissions is frequency conversion in non-linear crystals (frequency doubling). Non-linear crystals have the property of doubling the frequency of a portion of the input light resulting in an output wave having half the wavelength. For example, frequency doubling of an input source at 1064 nm (Yb fiber laser) results in an output wave of 532 nm (green light). The phenomenon of frequency conversion in non-linear crystals has been studied since the 1960's and has long been recognized as a mechanism for generating visible laser light.

Non-linear crystals can also act to mix two input sources to produce an energy beam having a frequency that is either the sum or the difference of the input frequencies (sum or difference frequency generation). Sum frequency generation is an example of a second order non-linear optical process. This phenomenon is based on the annihilation of two input photons at frequencies, λ₁ and λ₂ while, simultaneously, one photon at a higher frequency λ₃ (shorter wavelength) is generated. Difference frequency generation can lead to lower frequency (longer wavelength output).

For example, referring to FIG. 1, and also discussed in U.S. Pat. No. 6,763,042, there is a prior art fiber laser system generally indicated at 10 that utilizes non-linear conversion techniques to achieve a blue laser at the middle of the blue light spectrum (˜448 nm). The system 10 includes a first optical source 12 emitting light at 1064 nm and a second optical source 14 emitting light at 1550 nm. As can be seen, the first optical source 12 is a Ytterbium (Yb³⁺) fiber laser operating at 1064 nm. The light from this first source 12 is used in its original state. The second optical source 14 is an erbium (Er³⁺) fiber laser emitting at 1550 nm. The 1550 nm light beam is frequency doubled in a non-linear crystal converter 16 resulting in light at half the wavelength, i.e. 775 nm. The light form the first source 12 and the converter 16 are then combined and mixed in a non-linear sum frequency mixer (SFM) 18 resulting in light at a wavelength of 448.4 nm.

While this prior art system is effective for producing a high-power short-wavelength fiber laser device operating at a particular wavelength in the blue spectrum, there is still a continuing need to develop high-power, short-wavelength fiber lasers operating at different wavelengths within the blue spectrum.

### SUMMARY OF THE INVENTION

The instant invention provides a high-power, short-wavelength fiber laser device that combines the known advantages and well-developed technology of long-wavelength fiber lasers with the concepts of both non-linear frequency doubling and sum frequency mixing to generate visible blue laser light at a wavelength of about 427 nm.

As is well-known, fiber lasers provide an excellent source of infrared energy for coupling in external conversion cavities. Fiber lasers provide a simple source of high-power, narrow linewidth, single-mode infrared energy that can be controlled and delivered in a highly accurate manner. Fiber lasers are scalable in power and reliable in long-term operation. The present invention is directed to a high-power, short-wavelength fiber laser device that utilizes two independently operating distributed Bragg reflector (DBR) fiber lasers operating at different wavelengths.

The present fiber laser device preferably includes a thulium (Th³⁺) fiber laser emitting light at a wavelength of about 1900 nm, and an erbium (Er³⁺) fiber laser emitting light at a wavelength of about 1550 nm. The light from each of the respective fiber lasers is frequency doubled in respective non-linear converters, resulting in respective independent light sources operating at about 950 nm and about 775 nm. The resulting 950 nm and 775 nm light is combined and then mixed in a non-linear sum frequency mixer to produce a high-power, short-wavelength, single-mode beam of light having a wavelength of about 427 nm. The output of the present laser is highly useful in many different applications as outlined above.

Accordingly, among the objects of the instant invention are:

the provision of a high-power, short-wavelength fiber laser;

the provision of a high-power, short-wavelength fiber laser operating in the visible blue light spectrum;

the provision of a high-power, short-wavelength fiber laser that combines the known advantages and well-developed technology of long-wavelength fiber lasers with the concepts of both non-linear frequency doubling and sum frequency mixing to generate visible blue laser light; and

the provision of a high-power, short-wavelength fiber laser device that includes two fiber laser devices to provide a short-wavelength fiber laser in the visible blue light spectrum.

Other objects, features and advantages of the invention shall become apparent as the description thereof proceeds when considered in connection with the accompanying illustrative drawings.

### DESCRIPTION OF THE DRAWINGS

In the drawings which illustrate the best mode presently contemplated for carrying out the present invention:

FIG. 1 is a schematic view of a prior art short-wavelength fiber laser system;

FIG. 2 is a schematic view of the high-power, short-wavelength fiber laser constructed in accordance with the teachings of the present invention;

FIG. 3 is a schematic illustration of a rare-earth doped DBR fiber laser as used in the present invention;

FIG. 4 is a schematic illustration of a non-linear converter (frequency doubler); and

FIG. 5 is a schematic illustration of a beam combiner and non-linear sum frequency mixer.

### DESCRIPTION OF THE PREFERRED EMBODIMENT

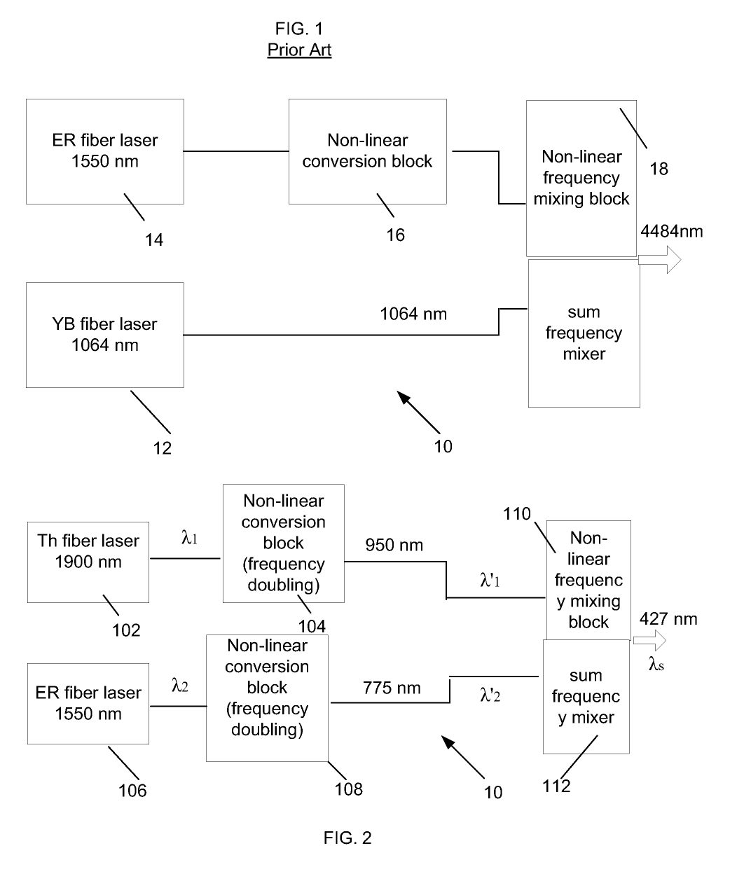

Referring now to the drawings, the fiber laser device of the instant invention is illustrated and generally indicated at 100 in FIG. 2. As will hereinafter be more fully described, the instant invention provides a high-power, short-wavelength fiber laser device 100 that combines the known advantages and well-developed technology of long-wavelength fiber lasers with the concepts of both non-linear frequency doubling and sum frequency mixing to generate visible blue laser light at a wavelength of about 427 nm.

As is well-known in the art, fiber lasers provide an excellent source of long-wavelength energy for coupling in external conversion cavities. Fiber lasers provide a simple source of high-power, narrow linewidth, single-mode energy that can be controlled and delivered in a highly accurate manner. They are scalable in power and reliable in long-term operation. The present invention is directed to a high-power, short-wavelength fiber laser device that utilizes two independently operating DBR fiber lasers operating at different wavelengths. The general operation and construction of DBR fiber lasers are well known in the art, and will not be described in detail herein.

Generally, the present fiber laser device 100 includes a first optical source generally indicated at 102, a first non-linear converter generally indicated at 104, a second optical source generally indicated at 106, a second non-linear converter 108, a beam combiner generally indicated at 110, and a non-linear sum frequency mixer generally indicated at 112.

In operation, the invention proposes to combine the concepts of non-linear frequency doubling of two different laser sources 102/106 and then sum frequency mix the two frequency doubled sources to generate visible laser light at a wavelength λₛ of between about 400 nm to about 700 nm. A specific configuration of the invention operating with an output at 427 nm is described further below.

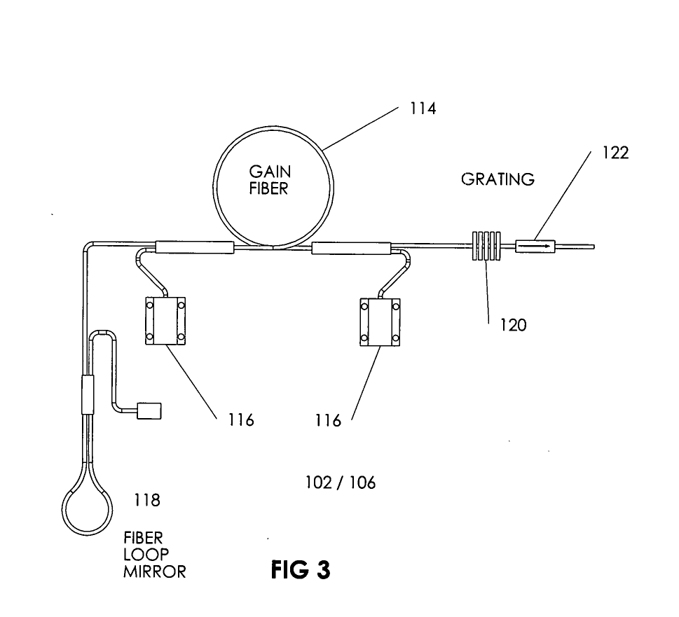

The first optical source 102 is preferably a fiber laser configured and arranged to emit a first light beam at a first wavelength λ₁. The fiber laser 102 has the general configuration as illustrated in FIG. 3, although, this disclosure should not be considered as limited to this specific configuration. The fiber laser 102 generally comprises a rare-earth active gain fiber 114, a pump source(s) 116, and a pair of reflectors 118,120 defining an optical cavity that includes the active gain fiber. Generally speaking in the broader context of the invention, the active dopant in the gain fiber 114 may include any of the known rare-earth ions to provide a fiber laser operating at the desired wavelength. Possible dopants can include, but at not limited to, Er³⁺, Tm³⁺, Yb³⁺, Pr³⁺, Ho³⁺and Nd³⁺. The pump source(s) 116 can comprise single or multimode diodes, diode arrays, or other fiber lasers operating at the desired pump wavelength, and can be configured in end pump, side pump, bi-directional pump, and other pump arrangements, as desired. The end reflector 118 is illustrated as a fiber loop mirror, although other reflector configurations are possible. The output reflector 120 is illustrated as a distributed bragg reflector (DBR), i.e. a grating written directly into a single mode fiber outside of the gain media, and is configured for output of a fixed wavelength. An optical isolator 122 is located on the output end of the fiber laser to prevent unwanted feedback. The output from a fiber laser 102/106 of this configuration is generally defined as a narrow linewidth, optical signal oscillating in a single fundamental mode (single frequency).

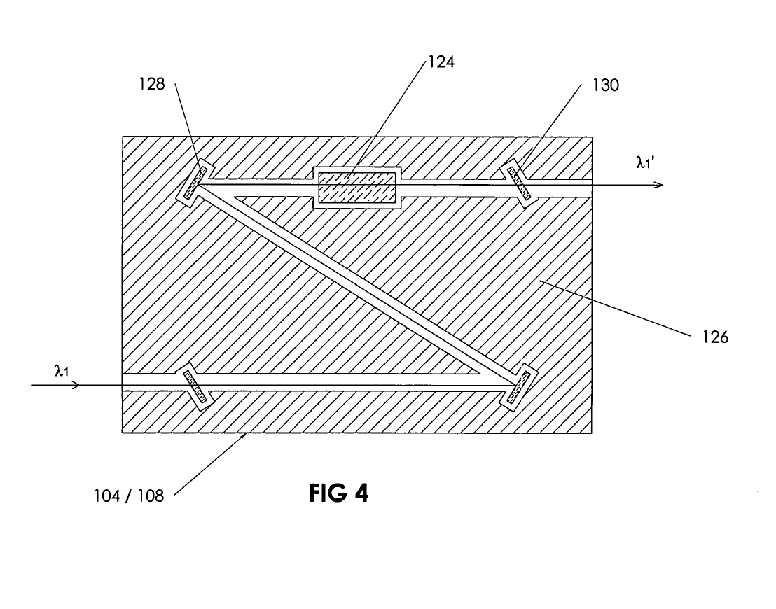

Light output from the fiber laser 102 is passed to a first non-linear converter 104 that is responsive to the first light beam for frequency doubling to produce a frequency-doubled first light beam at a wavelength λ₁′ of half said first wavelength λ₁ (λ₁′=0.5λ₁). The non-linear converter 104 preferably has the general bowtie configuration as illustrated in FIG. 4, although, this disclosure should not be considered as limited to this specific configuration.

Referring to FIG. 4, a non-linear crystal 124 is placed in the enhancement cavity 126 half-way between reflectors 128, 130. Non-linear crystals 124 which may be used include, but are not limited to potassium niobate, potassium titanyl phosphate, lithium niobate, lithium potassium niobate, lithium iodate, potassium titanyl arsenate, barium borate, beta-barium borate, lithium triborate, and periodically poled versions of these and similar crystals. The non-linear converter 104/108 as illustrated is not configured for a feedback system. However, such feedback systems are common in the art, and could be utilized in the present configuration.

The above geometry and arrangement may vary considerably depending on desired results, choices of non-linear crystal material, frequency control, source wavelength and other factors, and may be adjusted by those skilled in the art through routine experimentation.

The second optical source 106 is preferably a second fiber laser configured and arranged to emit a second light beam at a second wavelength λ₂. For purposes of the present invention, the second fiber laser preferably has the same general configuration as described hereinabove for the first laser 102, although should not be considered as being limited to the same.

The light output from the second fiber laser 102 is passed to a second non-linear converter 108 responsive to the second light beam for frequency doubling to produce a frequency-doubled second light beam at a wavelength λ₂′ of half said first wavelength λ₂ (λ₂′=0.5λ₂). The second non-linear converter 108 is also preferably a bow-tie configuration, and for purposes of the present invention, preferably has the same general configuration as described hereinabove for the first non-linear converter.

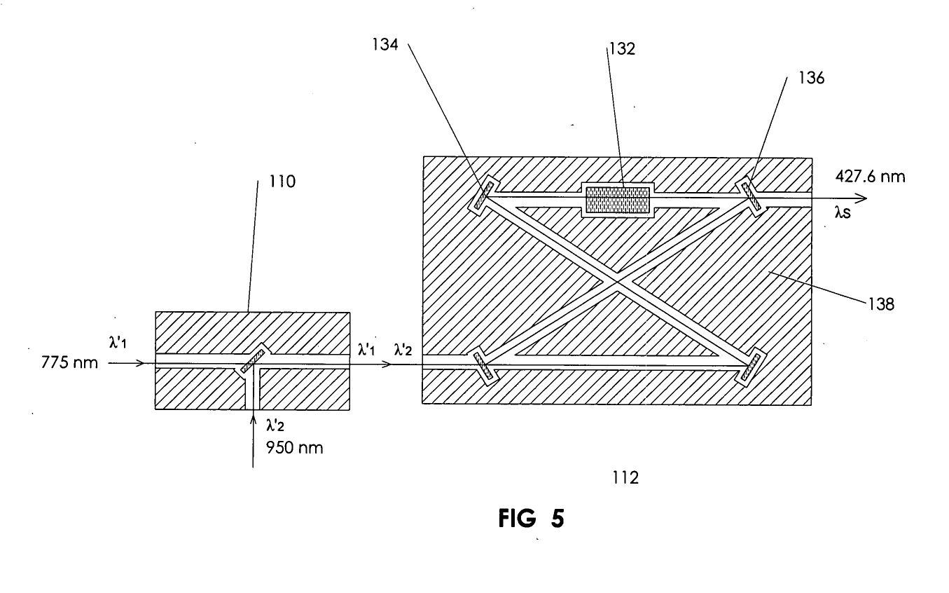

The two frequency doubled light beams λ₁′ and λ₂′ exiting from the respective non-linear converters 104,108 are then combined in a dichroic beam combiner 110 to produce a combined beam, which is further passed to a non-linear sum frequency mixer 112 responsive to the combined beam for sum frequency mixing the combined beam to produce a short wavelength beam of light λₛ in the spectral region from about 400 nm to about 700 nm. The beam combiner 110 and non-linear sum frequency mixer 112 preferably have the configuration illustrated in FIG. 5, although the disclosure should not be considered to be limited by this embodiment. The non-linear sum frequency mixer 112 generally has the same bow-tie configuration as the frequency doublers 104,108, wherein a non-linear crystal 132 is positioned between two mirrors 134,136 in the enhancement cavity 138. The non-linear crystal 132 generates a sum frequency emission at a wavelength λₛ according to the following formula:

λₛ=λ₁λ₂λ₁+λ₂

where λ₁ and λ₂ are the wavelengths of the incident beams.

The above describes the general operation and arrangement of the invention. Below is a specific embodiment of a laser 100 operating at a wavelength of about 427 nm, which is a highly desirable wavelength having uses in both the medical and dental fields.

Referring back to FIG. 2, the first optical source 102 preferably comprises a thulium (Th³⁺) doped fiber laser configured and arranged to emit a first light beam having a wavelength λ₁ of abut 1900 nm. The thulium gain fiber 114 is pumped at a pump wavelength of about 1550 nm. Preferably the pump source(s) 116 comprise erbium (Er³⁺) doped fiber lasers. The 1550 nm pump light stimulates an optical emission from the thulium fiber 114 in the range of 1900 nm, and more specifically, the fiber grating 120 forces oscillation of the fundamental mode at a wavelength of about 1900 nm. The light output from the thulium fiber laser 102 is then frequency doubled in the non-linear converter 104 to result in an output beam λ₁′ of 950 nm.

The second optical source 104 preferably comprises an erbium (Er³⁺) doped fiber laser configured and arranged to emit a second light beam having a wavelength λ₂ of about 1550 nm, The erbium fiber 114 is preferably pumped by multi-mode pump diode arrays 116 at a pump wavelength of about 975 nm. The pump light stimulates an optical emission from the erbium fiber 114 in the range of 1550 nm, and more specifically, the fiber grating 120 forces oscillation of the fundamental mode at a wavelength of about 1550 nm. The light output from the erbium fiber laser 106 is then frequency doubled in the second non-linear converter 108 to result in an output beam λ₂′ of 775 nm.

The resulting 950 nm and 775 nm light is combined in the dichroic beam combiner 110 and thereafter mixed in the non-linear sum frequency mixer 112 to produce a high-power, short-wavelength, single-mode beam of light having a wavelength of about 427 nm. The output of the described laser 100 is highly useful in many different applications as outlined above.

It can therefore be seen that the instant invention provides a high-power, short-wavelength fiber laser operating in the visible blue light spectrum, and further provides a high-power, short-wavelength fiber laser that combines the known advantages and well-developed technology of long-wavelength fiber lasers with the concepts of both non-linear frequency doubling and sum frequency mixing to generate visible blue laser light. The invention still further provides a high-power, short-wavelength fiber laser device that includes two tunable fiber laser devices to provide a tunable short-wavelength fiber laser in the visible blue light spectrum. For these reasons, the instant invention is believed to represent a significant advancement in the art, which has substantial commercial merit.

While there is shown and described herein certain specific structure embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed is:

1. A high-power, short-wavelength fiber laser device comprising:
a first optical source configured and arranged to emit a first light beam at a first wavelength λ₁, said first optical source comprising a first fiber laser;
a first non-linear converter responsive to the first light beam for frequency doubling to produce a frequency-doubled first light beam λ₁′ at a wavelength of half said first wavelength λ₁;
a second optical source configured and arranged to emit a second light beam at a second wavelength λ₂, said second optical source comprising a second fiber laser;
a second non-linear converter responsive to the second light beam for frequency doubling to produce a frequency-doubled second light beam λ₂′ at a wavelength of half said second wavelength λ₂;
a beam combiner configured and arranged to combine said frequency doubled first light beam λ₁′ and said frequency doubled second light beam λ₂′ to produce a combined beam; and
a non-linear sum frequency mixer responsive to the combined beam for sum frequency mixing the first and second light beams in the combined beam to produce a short wavelength beam of light λₛ in the spectral region from about 400 nm to about 700 nm.

2. The fiber laser device of claim 1, wherein the first and second non-linear converters include a non-linear optical crystal.

3. The fiber laser device of claim 1, wherein each of said first and second optical sources are DBR laser light sources.

4. A high-power, short-wavelength fiber laser device operating in the blue light spectrum comprising:
a first optical source configured and arranged to emit a first light beam at a first wavelength λ₁ of about 1900 nm, said first optical source comprising a Thulium-doped fiber laser;
a first non-linear converter responsive to the first light beam λ₁ for frequency doubling said first light beam λ₁ to produce a frequency-doubled first light beam at a wavelength λ₁′ of about 950 nm;
a second optical source configured and arranged to emit a second light beam at a second wavelength λ₂ of about 1550 nm, said second optical source comprising an Erbium-doped fiber laser;
a second non-linear converter responsive to the second light beam λ₂ for frequency doubling said second light beam λ₂ to produce a frequency-doubled second light beam λ₂′ at a wavelength of 775 nm;
a beam combiner configured and arranged to combine said frequency doubled first light beam λ₁′ and said frequency doubled second light beam λ₂′ to produce a combined beam; and
a non-linear sum frequency mixer responsive to the combined beam for sum frequency mixing the first and second light beams λ₁′,λ₂′ in the combined beam to produce a short wavelength beam of light having a wavelength λₛ of about 427 nm.

5. The fiber laser device of claim 4, wherein the first and second non-linear converters include a non-linear optical crystal.

6. The fiber laser device of claim 4, wherein each of said first and second optical sources are DBR laser light sources.
